(19) United States
(12) Patent Application Publication
(10) Pub. No.: US 2023/0255374 A1
(43) Pub. Date: Aug. 17, 2023

(54) SMART BOTTLE

(71) Applicant: RE-COMPANY SA, Geneva (CH)

(72) Inventors: Francesco ABBATE, Chambesy (CH); Pierandrea Quarta, Genf (CH); José Vicente VILLANUEVA LÓPEZ, Mont-Saxonnex (FR)

(21) Appl. No.: 18/005,476

(22) PCT Filed: Aug. 11, 2020
(86) PCT No.: PCT/EP2020/072543

§ 371 Date: Jan. 13, 2023

(51) Int. Cl. A47G 19/22; B65D 51/24; A47G 23/16

(52) U.S. Cl. CPC A47G 19/2227; B65D 51/24; A47G 23/16; A47G 2019/225

(57) ABSTRACT

Method for monitoring the use of a drinking bottle and a system for carrying out the method. A drinking bottle is designed to detect, on the basis of sensor data of at least one sensor, whether the dispensing of liquid from the drinking bottle is caused by drinking and to distinguish this from dispensing processes which do not represent drinking processes. An evaluation system collects sensor data of the at least one sensor. The evaluation system evaluates this sensor data, and if the dispensing was caused by a drinking process, stores the number of drinking processes and/or the volume of the liquid dispensing caused by drinking.

### FIELD OF APPLICATION AND PRIOR ART

The invention relates to a method for monitoring dispensing processes from a bottle as well as to a smart bottle system for carrying out this method.

Reusable drinking bottles are known from the prior art. Those bottles can be refilled by the user, for example with tap water. It is also known to provide such reusable drinking bottles with electronic components by means of which, for example, it can be detected how much liquid remains in the bottle or whether the user has drunk from the bottle sufficiently often. Such bottles are referred to as smart bottles. Examples of reusable smart drinking bottles including drinking cups with electronic components and closures therefor are known from various documents like US 2020/0029714 A1, US 2019/0298607 A1, U.S. Pat. No. 10,315,815 B2 and US 2017/0313479 A1.

It is desirable, especially for ecological reasons, that the user who uses the reusable drinking bottle and consumes water from this bottle instead of from drinking from disposable bottles which are usually not or only to a limited extent reused. Such disposable bottles represent a large proportion of the plastic waste produced by mankind. Many billions of such bottles every year are not recycled but end up in the environment.

In order to motivate users to consume as much water as possible from the above-mentioned reusable smart drinking bottles, it may be helpful to offer users the prospect of a benefit the more they use the bottle. By way of example, the emptying of such a bottle can be rewarded with a promise from the bottle supplier to collect a disposable bottle that has already been released into the environment and recycling it. The user of the bottle, when he has emptied a reusable bottle, has thus not only avoided the production of a disposable bottle, but has also ensured that a waste bottle that has already been released into the environment is collected and the environment is helped.

However, such a concept potentially bears the problem that in order to achieve the above-mentioned advantage, users may try to trick the electronics of the bottle, possibly even altruistically, in order to make the bottle show a higher consumption of water than the amount which has actually been consumed by drinking.

This could jeopardize the economic model of a supplier who, for example, in response to the emptying of bottles, takes over the collection of waste bottles from the environment.

### OBJECT OF THE INVENTION AND SOLUTION

The object of the invention is to provide a method for monitoring drinking processes in order to counter the above-mentioned danger. The object of the invention is furthermore to provide a corresponding system comprising a drinking bottle and conducting said method.

According to the invention a method for monitoring the use of a drinking bottle is proposed which is carried out by an evaluation system which has at least one sensor and preferably more than one sensor attached to a drinking bottle with a dispensing opening.

Said evaluation system is designed to detect based on the sensor data of the at least one sensor the dispensing of liquid from the drinking bottle caused by drinking and to distinguish it from dispensing processes which do not represent drinking processes.

According to the proposed method said evaluation system collects sensor data of the at least one sensor and evaluates the sensor data for detecting whether the dispensing has been caused by drinking or by another kind of dispensing process. Only if the dispensing has been caused by drinking or most likely by drinking, the evaluation system stores the number of drinking processes and/or the volume of the liquid dispensing caused by drinking in order to transmit this data later to a server or another kind of central storage.

According to the invention, it is therefore provided that through the evaluation system an evaluation takes place whether the dispensed liquid has actually been drunk or was only spilled without directly being drunk. Only in case that the at least one sensor provides sensor data that make a direct drinking process appear likely, the information about the extracted liquid quantity is processed so that it is finally sent to a server for storage.

Dispensing processes can be stored also if they have not been identified as drinking processes, but only drinking processes are counted such that the corresponding data is transmitted afterwards to cause the benefit promised to the user, especially the causing of a waste bottle being collected in the environment.

According to the invention the method is carried out by an evaluation system, which is at least partially provided on the drinking bottle itself. At least a sensor of the system is provided on the drinking bottle, wherein depending on the design of the sensor or the sensors these may be provided on a bottle body itself or on an outlet unit or closure unit with a cover or lid.

The evaluation system provided on the drinking bottle can represent the entirety of the user's personal evaluation system and can be capable of directly communicating with a server via the Internet or to initiate the recording of data in a storage or database. However, it is preferred that the evaluation system is divided into two partial units. It has a first subsystem on the drinking bottle itself, called the bottle evaluation unit, and a separate second subsystem, which is formed by a separate device, in particular by a mobile device such as a mobile phone or smart phone, which is connected to the bottle evaluation unit via a wireless interface such as Bluetooth, in particular BLE, or WiFi. Said second partial unit is called the external evaluation unit in this specification.

The method may provide that all dispensing processes identified as drinking processes independently of the kind of liquid are taken into account when processing the sensor data and potentially causing the promised benefit like the collecting of waste bottles.

However, it can be advantageous to let the method comprise a step of detecting at least one property of the liquid on the basis of sensor data and to assigned the liquid to one of at least two groups of liquids on the basis of this property in order to provide different ways of further processing.

Therefore, the benefit can be limited to specific liquids. For example, the method could distinguish between clear water and soft drinks and let only clear water cause the benefit.

In particular the method can be carried out by an evaluation system which has at least one temperature sensor attached to the drinking bottle. The evaluation system according to this embodiment can be designed to detect the liquid in the drinking bottle as a cold drink or hot drink based on temperature sensor data from the temperature sensor.

Distinguishing between cold drinks and hot drinks in the drinking bottle can be helpful because different sensors, which can be part of the evaluation system, can have different reliability depending on the temperature of the liquid. In particular, it has been found that sensors for detecting the liquid level in the drinking bottle, which are based on the detection of the reflection of an emitted signal by the surface of the liquid, can return incorrect results at hot temperatures caused by mist in the drinking bottle.

For this case and for similar cases it can make sense to provide an evaluation system designed to store the detected dispensing from the drinking bottle only as dispensing caused by drinking if the withdrawn liquid is categorized to belong to a specific group of liquids, in particular if the liquid has been identified by the temperature sensor as belonging to the group of cold drinks.

According to an advantageous embodiment the method is carried out by an evaluation system which has at least one volume detection sensor attached to the drinking bottle. Said volume detection sensor is preferably designed as a level sensor sensing the fluid level in the bottle. For example, the level sensor could be a capacitive sensor located in a wall of the bottle body or provided on a closure or spout unit and extending into the bottle body. Furthermore, the level sensor could be combination of an emitter and a detector for electromagnetic radiation. The level of the liquid can then be calculated on basis of the time of flight of the radiation beam until it reaches the detector after having been reflected by the liquid surface or on basis of the specific location on the detector being hit by the reflected beam.

The liquid volume sensor, in particular the liquid level sensor, is preferably used to repeatedly measure the liquid volume in the bottle. The evaluation system can calculate the dispensed volume from the drinking bottle on basis of the difference between the sensor data or data derived from the sensor data before and after the dispensing. In order to do so, the evaluation system preferably contains data regarding the shape of the bottle body or a correlation table containing sensor data and corresponding liquid volume levels.

Even if the evaluation system comprises a liquid volume sensor as described above if is advantageous that the system also comprises at least one inclination sensor attached to the drinking bottle, wherein the evaluation system is designed to detect an inclination of the bottle that allows liquid to flow out through the dispensing opening.

Such an inclination sensor makes it possible together with data on the remaining liquid volume in the bottle to determine whether the current inclination of the drinking bottle is sufficient to allow liquid to escape through the drinking opening of the bottle. In this way, the evaluation system can, for example, record the time during which a dispensing of liquid can take place.

This can be used, for example, to check on the basis of this whether a dispensing process has been plausibly a drinking process or if the flow rate seems to be too high for a drinking process. A mean volume flow during dispensing can be determined based on the time over which the drinking bottle was aligned in a sufficiently inclined position for liquid escape and the quantity of liquid dispensed, which is determined by comparing the measured values of the volume sensor before and after the dispensing. The resulting volume flow value can be compared with a threshold volume flow value in order to check whether it plausibly has been a drinking process. This threshold value is preferably below 80 ml/sec, especially below 50 ml/sec.

It is preferred that the evaluation system is designed to store the detected dispensing from the drinking bottle only as dispensing caused by drinking if the volume flow rate during dispensing is a reasonable drinking flow rate.

Another way to evaluate whether a dispensing process was probably caused by drinking the dispensed liquid is to record the environment and in particular the user by means of at least one sensor.

In particular it is preferred that the method according to the invention is carried out by an evaluation system which has at least one sensor attached to the drinking bottle which is suitable for detecting whether a user's face or head is in the vicinity of the dispensing opening. Thus, the evaluation system is able to store the detected dispensing from the drinking bottle only as dispensing caused by drinking if the user's face or head has been near the dispensing opening during the dispensing. If the user's face or head has not been detected, the dispensing has most likely not been a drinking process.

According to a possible embodiment the sensor for detecting the user's face is designed as a distance sensor, in particular as a time-of-flight sensor (ToF sensor), emitting a signal and measuring the time until the reflection of this signal is being received. Such a sensor placed in the vicinity of the spout opening thus measures the distance between the bottle or its spout and the face. During a drinking process this difference this distance is usually small, for example lower than 10 cm. If a significantly larger distance is being detected, it is unlikely or at least less likely that the face has been near enough for a drinking process.

According to a possible design the distance sensor, especially the time-of-flight sensor, is the same sensor as the sensor used for measuring the remaining volume in the botte by detecting the liquid surface. In order to use the same sensor for both the detection of the user's face during drinking and the liquid level in the bottle the sensor if preferable provided movable relative to the bottle body of the drinking bottle. Preferably the sensor is therefore located in a pivotable lid of a spout unit of the drinking bottle. When the lid is closed, the sensor faces inside the bottle body. When the lid is opened, the sensor faces toward the spout's vicinity and the user's face while drinking

An alternative kind of sensor for detection of the user's face or head is a temperature sensor. Such a temperature sensor can detect the temperature of near surfaces. If such a temperature sensor detects a surface temperature of significantly less than 36° C., like for example of 30° C., the dispensing process has most likely not been a drinking process. As described regarding the distance sensor it is also preferred for the temperature sensor that it is provided movably and in particular as part of a pivotable lid. This allows the temperature sensor to be used for both, the measuring of the temperature of the liquid within the bottle when the bottle is closed and the temperature of the vicinity and of the user's face if the bottle has been opened.

Preferably sensors of both kinds are being provided, a distance sensor, especially a time-of-flight sensor, as well as a temperature sensor. The usage of both kinds of sensors leads to a more reliable estimation on whether the user's face has been in a reasonable drinking position.

The evaluation whether the user's face is in the vicinity of the spout usually should take place shortly after the bottle has been opened. Therefore, it is preferred that according to the method an opening step is being detected, which, for example, can be done using a contact sensor or an acceleration sensor or an inertial measurement unit (IMU) sensing the click shake when the lid of the drinking bottle is being opened. Afterwards the distance sensor, the temperature sensor or another sensor for detecting the user is being polled.

According to another way of evaluation the method is carried out by an evaluation system which has at least one sensor capable of a detection of the user swallowing liquid. This can be a microphone coupled to a processor for audio analysis such that the swallowing sound or its absence can be detected and identified.

According to a preferred method, an inclination sensor and/or an acceleration sensor or an inertial measurement unit (IMU) sensing attached to the drinking bottle, preferably to its lid, is being used for detection of the swallowing. It has been found out that swallowing leads to a comparatively easy detectable acceleration curve at the drinking bottle, especially due to the periodicity of the individual swallows and the characteristic acceleration curve during a single swallow.

Depending on the detection of the swallowing the evaluation system stores the detected dispensing from the drinking bottle as dispensing caused by drinking.

In addition to or instead of the mentioned evaluation possibilities of the plausibility of the fluid volume flow during dispensing and the proximity of the face of the drinker, other sensor configurations are also possible. For example, with capacitive or resistive sensors, it is possible to detect whether the spout is enclosed by the user's mouth.

Regarding the evaluation, the described method also includes variants in which a result of one sensor is not evaluated on its own and causes a negative result independently of other sensors, but several different sensors are read out and the results are evaluated together. Thus, for example, if a swallowing acceleration is being detected with an insufficient probability of 45%, but together with a measured temperature of more than 35° C. by the face detection sensor, the overall probability may be sufficient high to assume that a drinking process is sufficiently plausible and to process the dispensing process as drinking process.

In order to achieve a low power consumption of a processor or an integrated circuit provided on the bottle, the sensor evaluation should preferably not be CPU intensive. In particular, the evaluation of the volume sensor, the temperature sensor and an acceleration and/or inclination sensor fulfil this particularly well. Since higher computing power and/or higher battery capacities are to be expected in the future, more complex evaluations can also be provided, especially decision procedures based on machine learning of trained systems that take into account sensor data from multiple sensors for the identification of drinking processes.

According to the invention a system is also provided, capable of monitoring the use of a drinking bottle.

This system primarily comprises the drinking bottle itself, which preferably has a bottle body made of metal and/or of plastic usually having a volume of more than 200 ml and of less than 1000 ml. Typical bottle bodies have a volume between 400 ml and 700 ml. The term “bottle” is not limited to a specific shape but covers all kinds of closable liquid containers.

The drinking bottle has a spout or opening which preferably is designed as part of a connected or connectable closure unit of the bottle, in particular a closure unit being fabricated separate from the bottle body and being attached to the bottle body using a thread or a snap connector. A removable cover or lid for covering the spout is provided, wherein a pivotable lid is preferred.

The drinking bottle system further comprises an evaluation system which is designed to carry out the methods described above. At least a part of the evaluation system is attached to the bottle, herein called the bottle evaluation unit. Preferably the bottle evaluation unit is at least partially located in the cover or lid.

The bottle evaluation unit has at least one sensor of the sensors described above and an integrated circuit or processor for at least basic data processing of data received from the at least one sensor. Furthermore, the bottle evaluation unit comprises an interface for sending the data to an external system. This interface is preferably a wireless interface, namely a Bluetooth interface, a WiFi interface or a cellular interface (3G, 4G, 5G). These interfaces can be used for a direct internet access of the bottle evaluation unit but are preferably used primarily for communication with an external unit of the evaluation system which can be a personal device of the bottle owner like a smart phone or another mobile device. This external part is primarily used for more CPU intensive processing, for storing data on drunk volume until a full bottle unit has been reached and for interaction with the user.

### SHORT DESCRIPTION OF THE DRAWINGS

Further advantages and aspects of the invention result from the claims and from the following description of a preferred embodiment of the invention, which is explained below using the figures.

FIG. 1 shows a drinking bottle system according to the invention including a drinking bottle with an internal bottle evaluation unit and a smart phone as external evaluation unit as well as a server the smart phone communicates with.

FIG. 2 shows the closure unit of the drinking bottle according to claim 1 with its internal components belonging to the bottle evaluation unit.

FIGS. 3A, 3B and 3C show the general intention of the method according to the invention and the consequences of the identification of a drinking process and a non-drinking dispensing process as well as the corresponding usage of the sensors of the bottle evaluation unit.

FIG. 4 shows a method diagram showing the procedure provided to distinguish drinking processes from non-drinking dispensing process.

### DETAILED DESCRIPTION OF THE EXAMPLES

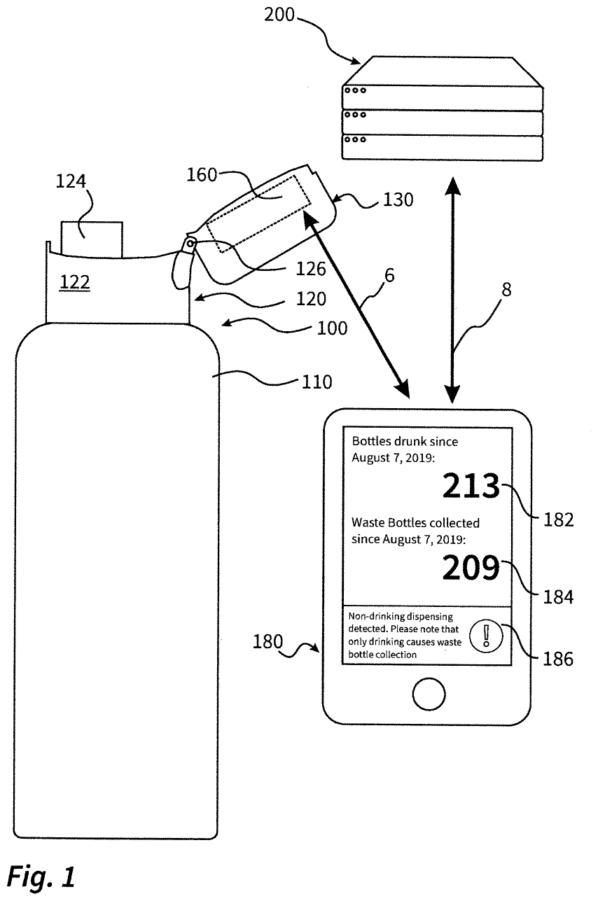

FIG. 1 shows a smart bottle system with its main components.

The system comprises a smart bottle 100 with a bottle body 110 which can be filled with a liquid. On the upper end of the bottle body a closure unit 120 is provided comprising a base 122 with a spout 124 for dispensing liquid. The closure unit 120 comprises a pivotable lid 130 which is connected to the base 122 via a hinge 126. Said lid 130 covers the spout 124 in a closed state and allows a user to dispense and drink liquid from the spout in an open state as shown in FIG. 1.

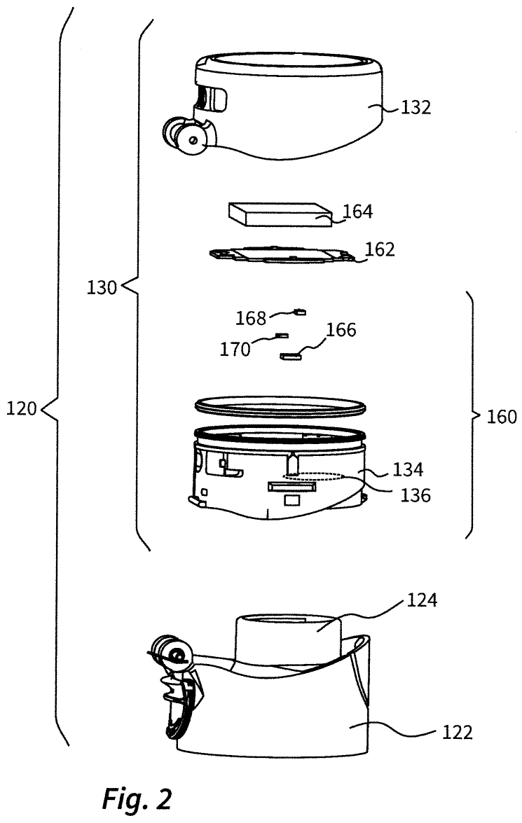

As shown by a dashed rectangle in FIG. 1 the lid 130 comprises an electronic bottle evaluation unit 160. The specific components being part of this electronic bottle evaluation unit 160 are shown in FIG. 2. The bottle evaluation unit 160 has various sensors 166, 168, 170 for detecting values regarding the liquid and the usage of the bottle. If furthermore comprises a wireless interface line a Bluetooth Low Energy (BLE) interface to establish data communication 6 with a mobile phone 180 and an application on this mobile phone acting as external evaluation unit 180.

The application on the mobile phone acting as external evaluation unit 180 is able to show relevant data regarding the dispensing history of the bottle 100 on the mobile phone's display. In this example information 182, 184 is shown on how many times the bottle content of 500 ml has been drunk and how many waste bottles have been collected as benefit.

Furthermore, the screen of the external evaluation unit 180 can show a warning message 186, which is displayed if liquid has been dispensed from the bottle, but most likely not by direct drinking. In such a case, the external evaluation unit 180 will indicate that the volume of liquid dispensed without directly drinking it will not lead to the collection of waste bottles.

The external evaluation unit 180 and the mobile phone on which the application is running is connected to the internet and in this example to a central server 200 in order to establish communication 8. The personal external evaluation unit 180 transmits information concerning the drunk liquid volume to the server 200 where this information is being stored. Based on the stored data on the server 200, service providers are commissioned to collect the corresponding number of bottles and send them to a recycling process.

FIG. 2 shows the closure unit 120 of the drinking bottle 100 with its internal components belonging to the bottle evaluation unit 160. The closure unit 120 comprises a base 122 which is connected to the bottle body 110, said base 122 providing a drinking spout 124 and a hinge 126 by which a pivotable lid 130 is being attached to the base 122.

This pivotable lid 130 comprises an inner shell part 134 and an outer shell part 132 which are being snapped together during assembly. Together this shell parts 132, 134 define a hollow space in which most components of the bottle evaluation unit 160 are located.

The bottle evaluation unit 160 comprises a printed circuit board assembly 162 (PCBA) having a CPU. On the upper side of the PCBA 162 a battery is located and connected to the PCBA 164. Below the PCBA 164 multiple sensors 166, 168, 170 are provided which are connected to the PCBA 162.

These sensors comprise a time-of-flight level sensor unit 166 which is located above an aperture 136 of the inner shell part 132. This level sensor unit 166 can send an electromagnetic radiation beam through the aperture 136. When the bottle is closed by the lid 130 and in an upright position, this electromagnetic radiation beam enters the bottle body and is being reflected by the surface of the liquid in the bottle body 110 and afterwards received by a receiver of the level sensor unit 166. The time the radiation beam needed for its way is being measured such that the liquid level in the bottle can be estimated.

A further sensor 168 is a temperature sensor. Although it is not in direct contact with liquid it is capable to detect the temperature in the bottle if the lid 130 is closed. In a preferred embodiment an aperture is provided in the inner shell 134 having a transmission element of high thermal conductivity which is in contact with the temperature sensor 168. With such an embodiment it has been found out that after only few seconds after closing the lid 130 the temperature sensor detects the correct temperature of the liquid inside the bottle body 110.

A third sensor 170 is an acceleration sensor or an inertial measurement unit (IMU) able to detect the acceleration applied on the sensor 170 in all three dimensions.

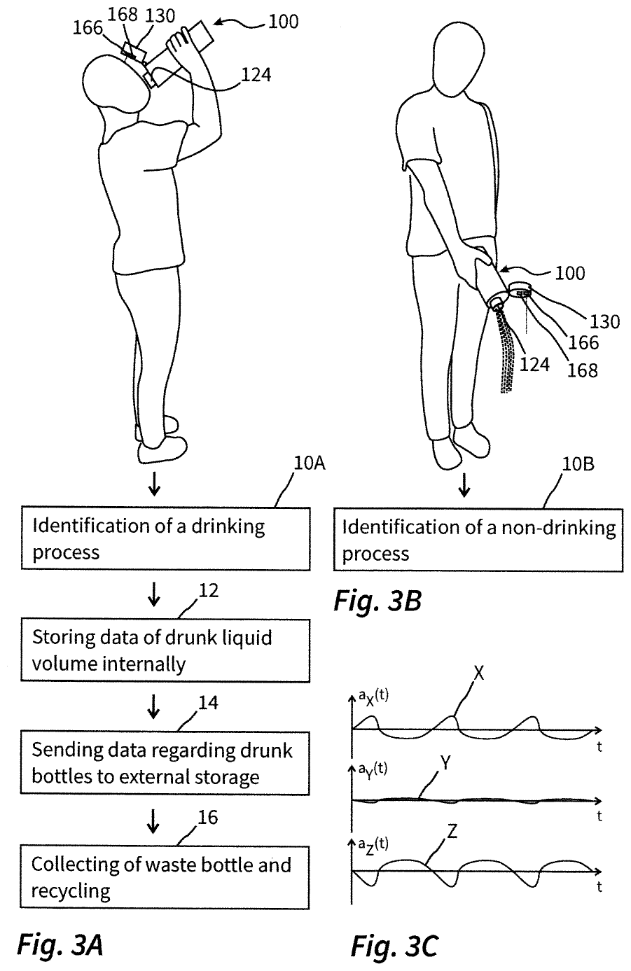

These sensors 166, 168, 170 are also being used for distinguishing a non-drinking dispensing process from a drinking dispensing process. This is shown in FIGS. 3A, 3B and 3C.

As shown in FIG. 3A a person is drinking from the drinking bottle 100 while the lid 130 is pivoted to an open position in which the spout 124 is accessible. The distance sensor unit 166 which detects the liquid level of the liquid in closed state of the bottle is now able to measure the distance to the user's head. During drinking this distance is usually below 10 cm. Furthermore, the temperature sensor 168 is located near the user's face and therefore detects a temperature of approximately 35° C.

The third sensor mentioned above, the acceleration sensor or inertial measurement unit (IMU) measures the acceleration in three dimensions X, Y and Z. FIG. 3C shows exemplary acceleration curves. As it can be easily seen from FIG. 3C and as also easily evaluated by the mentioned CPU the acceleration caused by swallowing shows periodic acceleration peaks. Such curves are typical for swallowing. Due to the characteristic curve a CPU with low performance is sufficient for detection of swallowing acceleration.

Therefore, when a person dispenses water from the bottle 100 by drinking, the sensors 166, 168, 170 return respective values typical for a drinking process. As consequence the volume dispensed from the bottle and measured by detecting the liquid level prior and after the dispensing process is being regarded a drunk water (step 10A). No warning is shown on the screen of the external evaluation unit 180 and instead data on the drunk liquid volume is stored in the external evaluation unit (step 12). As soon as a full bottle volume like for example 500 ml has been drunk, the external evaluation unit sends a message to the server 200 according to which one additional bottle has been emptied by the user (step 14). This causes the server to add one bottle to a counter for a subsequent order to collect waste bottles from the environment. Accordingly, the drinking of the bottle causes a waste bottle to be collected (step 16).

Contrary thereto when the liquid is simply poured to the ground as shown in FIG. 3B, the sensors 166, 168, 170 do not return sensor values typical for a drinking process. The distance sensor 166 measures more than 20 cm. The temperature sensor 168 measures the ambient air temperature of for example 20° C. The acceleration sensor 170 returns acceleration curves not showing the periodicity as shown in FIG. 3C. Therefore, it can easily be detected that most likely not drinking process took place but instead the water has been spilled. The dispensing process is therefore identified as non-drinking process and accordingly the steps 12, 14, 16 described above do not take place.

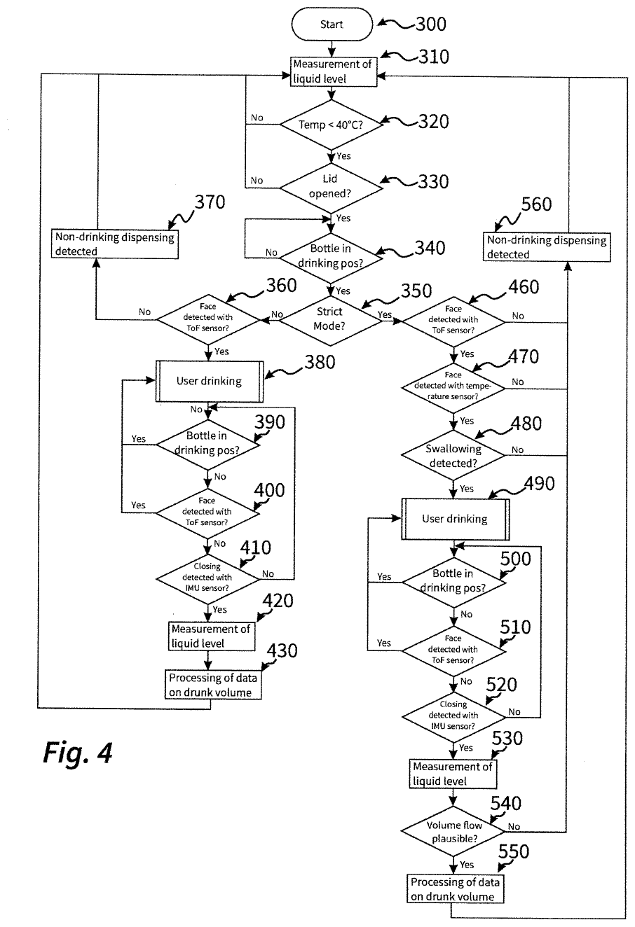

An example of method steps for distinguishing drinking processes from other dispensing processes is shown in FIG. 4.

After the procedure has been started (step 300) a measurement takes place using the time-of-flight distance sensor (step 310). In case the temperature of the liquid is below 40° C. and the sensors are thus able to work as expected (step 320) and the lid (130) has been opened which can be detected using the IMU (step 330) it is waited until a drinking position of the bottle has been reached (step 340).

As soon as the drinking position has been reached, it is checked (step 350) whether a strict drinking detection mode or a softer detection mode shall be used. Such an embodiment with at least two possible modes of detection can for example select the mode to be used based on the credibility of the user or on basis of his drinking history.

In soft mode (left branch) it is only checked at the beginning whether the user's face can be detected using the time-of-flight sensor.

In case the time-of-flight sensor does not show an obstacle, namely the user's face, within a distance of 20 cm, it is assumed that this is no real drinking process (step 370). Therefore, the method returns to a new measurement of the liquid level and to the detection of the beginning of a dispensing process (steps 320, 330).

In case the user's face has been detected in step 360 it is assumed that the user is now drinking (step 380). If the sensors return sensor data according to which the drinking process has ended (steps 390, 400, 410) a further measurement of the liquid level takes place and data regarding the evaluated drunk volume is sent to the external evaluation unit 180 for further processing and for aggregated transmittal to the server 200.

In strict mode (right branch) it is also checked at the beginning whether the user's face can be detected using the time-of-flight sensor 166 (step 460). If the user's face is not detected within a distance of 20 cm, it is assumed that this is no real drinking process (step 560). This assumption is also made in case that no plausible face temperature is being detected (step 470) or no swallowing is being detected (step 480).

If all requirements according to steps 460, 470, 480 are fulfilled it is assumed preliminarily that the user is drinking liquid (step 490). During his drinking process the total time is measured during which the bottle 110 is in a sufficiently inclined position to dispense water. If according to steps 500, 510, 520 the drinking process has ended, the remaining liquid in the bottle is being measured (530) and afterwards the mean flow rate is calculated (step 540).

Only if the volume flow rate is being regarded as plausible (step 540) the evaluated drunk volume is sent to the external evaluation unit 180 for further processing and for later aggregated transmittal to the server 200. If the mean volume flow rate is above a plausible threshold value, for example above 40 ml/sec, the dispensing process is not regarded as drinking process (step 560).

1. A method for monitoring use of a drinking bottle comprising:
providing an evaluation system with at least one sensor attached to a drinking bottle with a dispensing opening;
detecting, with the evaluation system on the basis of sensor data of the at least one sensor, whether the dispensing of liquid from the drinking bottle was caused by drinking and distinguishing this from dispensing processes not caused by drinking processes;
collecting, with the evaluation system, sensor data of the at least one sensor; and
evaluation, with the evaluation system, the sensor data for detecting whether the dispensing has been caused by drinking and storing the number of drinking processes and/or the volume of the liquid dispensing caused by drinking.

2. The method according to claim 1, further including:
detecting at least one property of the liquid on the basis of the sensor data and assigning the liquid to one of at least two groups of liquids on the basis of this property.

3. The method according to claim 1, further including:
providing the evaluation system with at least one volume detection sensor attached to the drinking bottle; and
using the volume detection sensor to repeatedly measure a liquid volume in the bottle, and calculating, with the evaluation system, the dispensing from the drinking bottle on the basis of a difference between the sensor data, or data derived from the sensor data, before and after the dispensing.

4. The method according to claim 3, further including:
providing a level sensor as the volume detector sensor, and sensing the fluid level in the bottle with the level sensor.

5. The method according to claim 1, further including:
providing the evaluation system with at least one inclination sensor attached to the drinking bottle; and
detecting, with the evaluation system, an inclination of the bottle that allows liquid to flow out through the dispensing opening.

6. The method according to claim 1, further including:
storing, with the evaluation system, the detected dispensing from the drinking bottle only as dispensing caused by drinking if a volume flow rate during dispensing is a reasonable drinking flow rate.

7. The method according to claim 1, further including:
detecting, with the at least one sensor, whether a user's face is in the vicinity of the dispensing opening; and
storing, with the evaluation system, the detected dispensing from the drinking bottle only as dispensing caused by drinking if the user's face was near the dispensing opening during the dispensing.

8. The method according to claim 7, further including:
providing a distance sensor as the at least one sensor and using the distance sensor as a liquid level sensor for detecting the liquid level in the drinking bottle.

9. The method according to claim 7, further including:
detecting whether the drinking bottle has been opened; and
thereafter evaluating the sensor data to determine whether the user's face is in the vicinity of the dispensing opening.

10. The method according to claim 1, wherein:
the at least one sensor is configured to detect the user swallowing liquid; and
the method further includes storing, with the evaluation system, the detected dispensing from the drinking bottle only as dispensing caused by drinking if swallowing has been detected.

11. A system for monitoring the use of a drinking bottle, the system comprising:
a drinking bottle; and
an evaluation system comprising a bottle evaluation unit attached to the drinking bottle, the bottle evaluation unit comprising at least one sensor configured to provide sensor data, the at least one sensor comprising a face detection sensor or an inclination sensor, the evaluation system being configured to detect, on the basis of the sensor data, whether a dispensing of liquid from the drinking bottle was caused by drinking or whether a dispensing of liquid from the drinking bottle was not caused by drinking, and further being configured to evaluate the sensor data and to store a number of drinking processes and/or a volume of liquid dispensing caused by drinking.

12. The system according to claim 11, wherein:
the drinking bottle has a bottle body and a closure unit configured for opening and closing; and
the bottle evaluation unit is at least partially provided in the closure unit.

13. The system according to claim 11, wherein
the system comprises an external evaluation unit as part of the evaluation system, said external evaluation unit being connected wirelessly to the bottle evaluation unit.

14. The method according to claim 2, wherein:
the evaluation system has at least one temperature sensor attached to the drinking bottle, and the method includes detecting, with the evaluation system, whether the liquid in the drinking bottle is a cold drink or a hot drink on the basis of sensor data from the temperature sensor.

15. The method according to claim 4, including providing a time-of-flight sensor as the level sensor.

16. The method according to claim 6, further including only storing the dispensing from the drinking bottle as dispensing caused by drinking when an average volume flow rate is below a threshold value.

17. The method according to claim 16, wherein the threshold value is below 80 ml/sec.

18. The method according to claim 7, wherein the at least one sensor is a temperature sensor.

19. The method according to claim 8, wherein the distance sensor is located on a pivotable lid of the drinking bottle.

20. The method according to claim 10, further including providing an inclination sensor or an acceleration sensor attached to the drinking bottle as the at least one sensor configured to detect the user swallowing liquid.

21. The system according to claim 12, wherein the closure unit includes a pivotable lid and the bottle evaluation unit is at least partially located in the pivotable lid.

22. The system according to claim 13, wherein the external evaluation unit comprises a mobile device including an application for connecting with the bottle evaluation unit via Bluetooth or WiFi and with an external server via the Internet.

23. The system according to claim 11, wherein the at least one sensor comprises a face detection sensor and the face detection sensor comprises a distance sensor or a temperature sensor.

24. The method according to claim 14, further including storing, with the evaluation system, the detected dispensing from the drinking bottle only as dispensing caused by drinking if the dispensed liquid has been identified by the temperature sensor as belonging to one of the at least two groups of liquids.
